(19) United States
(12) Patent Application Publication
(10) Pub. No.: US 2014/0041290 A1
(43) Pub. Date: Feb. 13, 2014

(54) Accelerated aging mini chamber for global seed vigor test

(71) Applicant: INTA Instituto Nacional de Technologia Agropecuaria, Buenos Aires (AR)

(72) Inventor: Jorge Otermin, Rosario (AR)

(21) Appl. No.: 13/965,826

(22) Filed: Aug. 13, 2013

(30) Foreign Application Priority Data
Aug. 13, 2012 (AR) 20120102052

(51) Int. Cl. A01C 1/02

(52) U.S. Cl. CPC A01C 1/025
USPC 47/14

(57) ABSTRACT

A Mini Chamber is of the type constituted by a plastic container with a top closure lid, inside which a reticulated mesh basket is housed, extended in a horizontal plane, on which the seeds are arranged, which is removably mounted on an intermediate height above the volume of water contained in the bottom of said container. The novelty lies the plastic container is a cylindrical body of vertical axis and circumferential section, with an open top base on which a dome shaped top closure lid is placed. The invention considers the plastic container may be slightly conical, tapering towards its lower base. Preferably, both the top closure lid and the container itself are made of a transparent plastic material such as polycarbonate or polypropylene.

### SCOPE OF THE INVENTION

The present invention has as a main objective an ACCELERATED AGING MINI CHAMBER FOR GLOBAL SEED VIGOR TEST, comprising a very special plastic container with a novel constructive design which brings a set of advantages of a functional nature compared to everything that is known to today.

More specifically, the present invention features a new mini chamber comprising a container with a substantially cylindrical base, closed by a transparent dome-shaped lid inside which a seed receiving basket is housed which is easily removably mounted.

As is per se known, this mini chamber belongs to the type that is required for seed vigor test, for which a volume of water contained inside the mini chamber is used, whereby a high relative humidity environment in the tested seeds is generated, while the mini chamber is placed into an incubator in order to keep it at a predetermined temperature for an established time, conducting an Accelerated Aging (AA) Test.

In this particular case the invented mini chamber has a new design that includes the possibility of containing up to 400 seeds, (which is an amount required by international standards in this field to conduct quality tests), being the design highly efficient, especially because it avoids the inadequate wetting of the seeds that usually occurs upon contact with free water from condensation in the inside of the enclosure, while it is distinguished by the easy removal of the inner basket carrying the seeds.

This is an invention that defines a new media combination conceived to achieve a higher result, being the same unpredictable and surprising even to one skilled in the art. Consequently, besides being new, its constructive and functional conception shows a clear inventive activity, thus it meets the conditions required by Law to be deemed as an invention patent.

### PRIOR ART

The term Mini Chamber for accelerated aging test is used to identify devices used in order to simulate different climatic possibilities to evaluate the behavior of the test object in such environmental conditions.

The accelerated aging test involves subjecting the seeds to stressful conditions of high temperature and relative humidity, which aims to estimate the vigor status of the batch to be subjected to analysis.

It is known that depending on the requirements of the test, a greater or lesser number of samples with a certain number of product units to be analyzed in each case are required.

For this reason, this type of mini chambers have been designed to control parameters such as temperature, humidity and light intensity, being able to also handle other variables such as pressure, CO2, according to the specifications set in each test.

As indicated above, a Mini Chamber of this type essentially comprises a plastic container with a lid, inside which the seeds to be submitted to accelerated aging process are placed, prior to conducting the standard germination test required as an indicator of quality in the domestic and international trade of seeds.

Usually, a mini chamber as stated above may be required to control the following characteristics:
Control of temperature in a biological range (5° to 45°±1°) with digital display of the value.
Lighting level on each shelf.
Temperature and lighting (photoperiod) cycling in programmable day/night cycles.
Control of 45%-95% humidity with an evaporation or ultrasound humidification system.

Through these tests, an agricultural producer can know if the seed is adapted to the soil and climate of the region, allowing to calculate the seed density, a critical parameter to use the area to be sown.

Even the banks or financial organizations will be able to evaluate more accurately the potential risk of lending for sowing as they can estimate the yield of a crop.

Mini chambers and not chambers having a greater capacity are used because the stress effect achieved on the seeds is the same, with much lower operating cost. Mini chambers require less physical space in the laboratory; conventional, commonly available incubators may be used; mini chambers do not require sophisticated maintenance; and any kind of cross-contamination of pathogens between batches is avoided (individual containers with lids for each sample).

It should also be noted that this type of mini chambers can be used in other types of tests (e.g., health tests, re-wetting or “priming” of seeds).

There are other chambers for Accelerated Aging for multiple samples; they generate stress conditions similar to those obtained with the use of Mini Chambers, but they are expensive and not available in the market, require a large physical space in the laboratory, require rigorous maintenance and sophisticated control of the process, are less versatile because they can not be used for other types of tests, the seeds are placed in open baskets which promotes cross-contamination by pathogens, are restricted for many samples simultaneously and their repairing is costly.

Regular users of these Mini Chambers are Seed Laboratories accredited by the International Seed Testing Association (ISTA), based in Switzerland, and also the Association of Official Seed Analysts (AOSA), based in the U.S., all of which are distributed in 127 member countries, where the Accelerated Aging Test in different species is practiced routinely.

For example, the Accelerated Aging Test practiced in soybean species, to be duly accepted in all these countries, must be performed by the accredited mentioned laboratories, which are required to run the test under the standards laid down by the International Rules for Seed Testing Seed, published by ISTA.

Accelerated Aging Test is considered a laboratory test for the determination of Vigor of a seed batch by analyzing a representative sample. The methodology involves subjecting the seed sample to stress that highlights the physiological conditions of the seeds.

Stressful conditions combine high temperature (40° C.-45° C.), high relative humidity (near 100%) and a variable period of time (48-144 hours, depending on the species).

The seeds are impaired by increased respiratory activity as a result of an increase in its internal moisture content while in the Mini Chamber at high temperature conditions for a period of time. In this regard it is noted that, during the analysis, the seed must not increase its internal moisture content by direct contact with water, but a slow absorption of water vapor which is set inside the enclosure.

For soybean species, stress conditions used are 41° C. to 95% (or more) relative humidity and 72 hours of exposure.

A conventional procedure comprises:
1. Place 40 milliliters of water in the base of the Mini Chamber;
2. Place the basket carrying 200 pre-weighed seeds over the base of the Mini Chamber;
3. Place the lid of the Mini Chamber and enter it into an incubator, for the time set for the species. After the stress period, the seeds are removed from the Mini Chamber and within a period no longer than 1 hour a Standard Germination Test in the substrates recommended by ISTA (Between Papers, on Paper with Sand or Sand) must be performed.
4. After the period of the Standard Germination Test, the seedlings obtained in the test are evaluated and classified according to the criteria in the Seedlings Assessment Manual by ISTA.
5. The result of the Accelerated Aging Test is expressed as percent of Normal Seedlings and this value represents the Vigor of the batch.

Also known are various invention patents which relate to these methods and test devices, wherein this type of mini chambers, suitable for vigor seed test, are reported. European Patent EP 2,365,314 discloses a method and apparatus for accelerated aging test (100) including a radiation source (108), a temperature adjustment source (110), and a moisture adjustment source (112), which are still linked to a controller resource (114). Inside it, a test sample (101) is placed, which is subjected to operating parameters that are present in the interior of a test chamber (104).

The invention patent U.S. Pat. No. 4,230,983 discloses a method and apparatus for automatically testing seed characteristics.

The apparatus has a seed carrying tray that keeps the seeds exposed inside an enclosure containing distilled water. After a given period, characteristics of tested seed such as viability, vigor and physical damage may be established. The apparatus includes a probe with electrodes to measure the absorption of moisture from the seeds.

The invention patent application publication U.S. 2009081633 shows a mini chamber for germination test defining an enclosure with a lid linked to an oxygen supply means.

The base of the enclosure contains water, and oxygen is dispensed from a liquefied gas tube. Thus, an enclosure with a high moisture content to which the seeds are exposed is established.

Publication U.S. 2009077873 also discloses a device for accelerated aging test comprising a box inside which a seed carrier tray is arranged which is maintained above the bottom resting on flanges projecting from the box wall.

At the bottom of the box an aqueous solution fed from a bypass channel is included.

The set comes complete with a plastic lid for the top closure.

In all of these previous disclosures, Mini Chambers preferably constructed of plastic, especially acrylic or polycarbonate, all of which have a prismatic geometric design, particularly a parallelepiped shape, with hinged lid are invariably used.

Generally, they define a volume of 11.0 cm side×11.0 cm side×3.5 cm high, and are also distinguished because both the base and the container lid are transparent.

Inside the container, a basket or holder comprising a quadrangular frame supported by four similar corner legs, which contains and encloses a quadrangular reticulated mesh, extended in a horizontal plane, which may be of plastic or metal, is placed.

On this metal mesh, seeds are placed neatly spread and maintained properly off the bottom of the enclosure.

Analyzing the behavior of these known Mini Chambers, some use and operation disadvantages are clearly seen, among which are the following:
1. Possibility of water condensation on the inside of the flat lid, which drip down on the seeds tested, generating an additional and improper wetting factor disrupting the behavior of the seeds. Clearly, the presence of a flat cover favors the dripping of condensed water vapor inside the container on the seeds.
2. Being prismatic units, when they are placed inside the incubator to be subjected to the action of a homogeneous heat, they must be spread with some mutual spacing, allowing hot air to circulate between them. This requirement is a clear limitation of the loading capacity, wherein the physical dimension prevents working with a higher number of seeds. It is clear then that the rectangular prismatic shape of known and conventional mini chambers requires a separation of at least 2.5 cm between the containers, to promote circulation of hot air inside the incubator and avoid temperature stratification.
3. It may also be argued that the same geometric reason is also limiting physical dimension that prevents working with a higher number of seeds of the same species, or other species.
4. As a consequence of such geometric conformation the little use of the internal physical space of the incubator is noted.
5. It is also highlighted that the rectangular prismatic shape of the container complicates cleaning in the inner angles and microorganisms that contaminate the next sample can be retained.
6. Difficulty in removing the basket from the container.
7. It is necessary to conduct the Standard Germination Test within a period of 1 hour from the Mini Chamber exits from the incubator.

### DESCRIPTION OF INVENTION

The Accelerated Aging (AA) Mini Chamber for global seed vigor test referred in the present invention clearly overcomes the drawbacks above mentioned, from a novel constructive design of its constitutive container and lid.

This is a plastic container with a specific design especially developed for the purpose, comprising a cylindrical-shaped base body, on which a top closure lid dome-shaped is arranged. Thus, an enclosure is defined within which a well-known seed carrying basket, extended in a horizontal plane, of the type comprising a flat reticulated mesh easily removably mounted should be placed.

This is an embodiment able to contain up to 400 seeds (amount required by ISTA Rules to conduct quality testing) which is distinguished especially by the aforementioned cylindrical body design combined with a dome-shaped lid.

In fact, the mini chamber of this invention has as a constructive condition the top closure lid is a dome resting on the top edge of the container which is a cylindrical body of vertical axis. Consequently, any condensation occurring on the inner surface of said lid, run through the same without dripping, moving to the side cylindrical wall of said base body, from which it advances and falls to the bottom.

Thereby, any possibility the heat exchange takes place during the test producing an undesired dripping on the seeds distributed in the basket extended on the horizontal plane over the water volume level contained in the bottom, is eliminated.

It is clearly understood that the design of the dome-shaped lid is what allows the condensed water vapor in the inside drains on its inner surface towards the container base eliminating any possibility of direct contact of the seed with the condensed water forming said droplets.

Said lid may form a hollow hemispherical lid.

This novel conformation provides other advantages of a functional nature which can all be summarized as follows:
The design of the dome-shaped lid, prevent direct dripping of condensed water vapor on the seed.
This novel dome shape of the lid also facilitates convective currents of moist air into the container, causing a uniform distribution of water vapor.
The aforementioned lid shape also facilitates cleaning, eliminating the need to access to hard to reach areas.
The shape of the lid also allows to have a longer time interval between the removal of the mini chamber from the incubator and the sowing in the Standard Germination Test.
This novel design of the anti-dripping lid also allows to leave the Mini Chamber closed after removal from the incubator until the time the Standard Germination Test is performed, preventing moisture loss from the seed.
The inner basket is easily removed from the container base because when it is removably positioned, it has a slight upper edge which allows take it with fingers in a very simple and direct way.
Finally, it should be noted that the mentioned circular cylindrical format allows two mini chambers contacting one to the other have only a single point of contact, with enough space between them to promote the circulation of hot air inside the incubator, thus the inner space of the incubator is used much more efficiently, increasing the load capacity to carry out the corresponding tests.

Inventive Activity

No any Accelerated Aging Mini Chamber known at present proposes, or even suggests a constructive solution arising from the indicated in the preceding paragraphs, which is why it is a novel proposal that has also a clear inventive activity.

### BRIEF DESCRIPTION OF FIGURES

To achieve the advantages briefly commented, to which the users and the ones skilled in the art could add many more, and to facilitate the understanding of the constructive, constitutive, and functional characteristics of the invented mini chamber, a preferred example of embodiment follows, which is illustrated schematically and without a determined scale in the attached sheet, with the expressed clarification that, precisely, for dealing with an example, it does not correspond to assigning a limiting or exclusive character to the scope of protection of the present invention patent, rather, it is merely explicative or illustrative of the basic concept of this invention.

FIG. 1 is a perspective view showing the mini chamber of this invention observed from outside.

FIG. 2 is a vertical sectional view of the same mini chamber depicted in the previous figure.

FIG. 3 is a schematic vertical section showing the same mini chamber of the previous figures wherein the seed carrying basket and a volume of water contained therein is included.

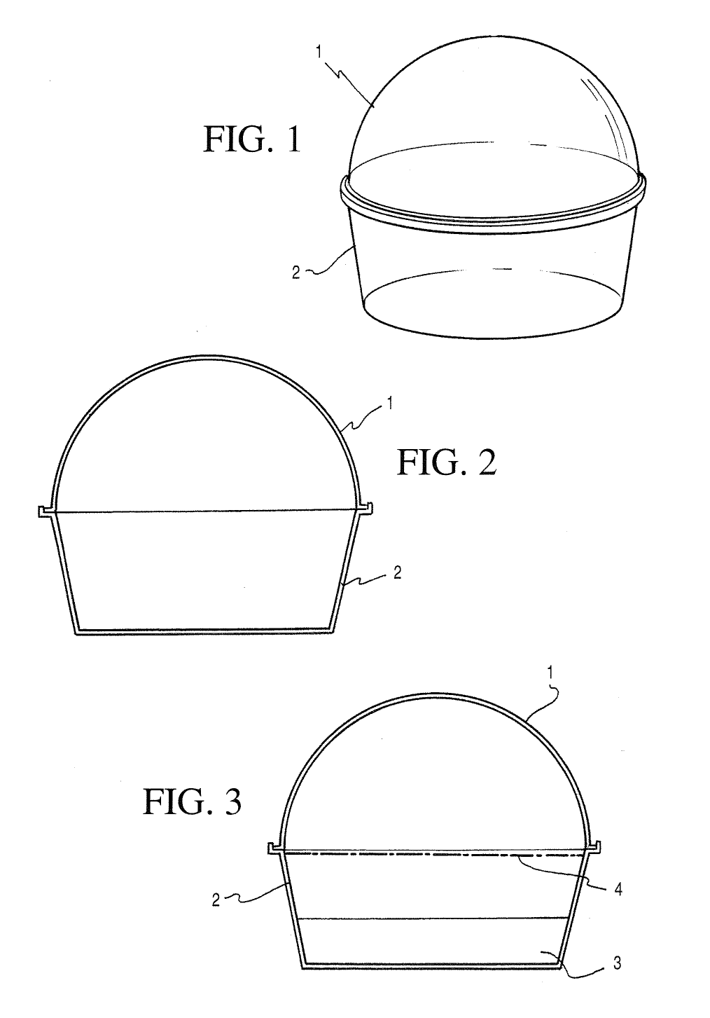

It is clarified that in all the figures, to the same reference numbers correspond the same or equivalent constitutive parts or elements of the set, according to the example chosen for the present explanation of the invented MINI CHAMBER.

### DETAILED DESCRIPTION OF A PREFERRED EXAMPLE

As can be seen in the figures the mini chamber referred in the present invention has a cylindrical container (1) with a circular flat base, on which a lid (2) distinguished by its dome shaped design is placed.

In a preferred embodiment both the container (2) and the lid (1) are made of a transparent plastic material able to resist temperatures about 50° C.-60° C., such as polypropylene, polycarbonate or equivalent.

As explained above and shown in the diagram in FIG. 3, inside said container (2) a volume of water (3) is placed which is incorporated to generate a high relative humidity environment, which affects the seeds arranged neatly on the discoidal basket (4) extended on the horizontal plane.

Thus a novel mini chamber is constituted, with a special constructive design, adequate to be placed inside an incubator wherein is subjected to the action of a temperature between 40° C.-45° C., generating a high relative humidity (over 90%) which is maintained by a pre-set time, which may vary (depending on the species of the seed) between 48 hours and 144 hours, to conduct the Accelerated Aging Test in accordance with international standards.

It is a condition of the invention that the mentioned container (2) is a cylindrical body of vertical axis and circular base, considering that is slightly conical, with a cross-section tapering towards the lower base.

Also, in preferred embodiments, the wall thickness may vary between 2 mm and 3.5 mm, both for the container body (2) and the lid (1).

As it is schematically shown in FIG. 3, to carry out the aforementioned accelerated aging test, the invented Mini Chamber takes into account the seed carrying basket (4) is resting on the top circumferential perimeter of the container (2), for which other options are included, such as resting on teeth or internal flanges which project inwardly from the cylindrical wall, or extending on legs that are supported directly in the bottom of the container.

Said inner basket may be of plastic or wire.

1.—ACCELERATED AGING MINI CHAMBER FOR GLOBAL SEED VIGOR TEST, of the type constituted by a plastic container with a top closure lid, inside which a reticulated mesh basket is housed, extended in a horizontal plane, on which the seeds are arranged, which is removably mounted on an intermediate height above the volume of water contained in the bottom of said container, characterized by the plastic container is a cylindrical body of vertical axis and circumferential section, with an open top base on which a dome shaped top closure lid is placed.

Six (6) claims are following.

Having described and exemplified the nature and main object of the present invention, as well as how the same may be put into practice, it is claimed as exclusive property and right:

1. ACCELERATED AGING MINI CHAMBER FOR GLOBAL SEED VIGOR TEST, of the type constituted by a plastic container with a top closure lid, inside which a reticulated mesh basket is housed, extended in a horizontal plane, on which the seeds are arranged, which is removably mounted on an intermediate height above the volume of water contained in the bottom of said container, characterized by the plastic container is a cylindrical body of vertical axis and circumferential section, with an open top base on which a dome shaped top closure lid is placed.

2. ACCELERATED AGING MINI CHAMBER FOR GLOBAL SEED VIGOR TEST, as claimed in 1, characterized by the plastic container is slightly conical, tapering towards its lower base.

3. ACCELERATED AGING MINI CHAMBER FOR GLOBAL SEED VIGOR TEST, as claimed in 1, characterized by the top closure lid is a hollow hemispherical lid.

4. ACCELERATED AGING MINI CHAMBER FOR GLOBAL SEED VIGOR TEST, as claimed in 1, characterized by the top closure lid is made of a transparent plastic material such as polycarbonate.

5. ACCELERATED AGING MINI CHAMBER FOR GLOBAL SEED VIGOR TEST, as claimed in 1, characterized by the top closure lid is made of a transparent plastic material such as polypropylene.

6. ACCELERATED AGING MINI CHAMBER FOR GLOBAL SEED VIGOR TEST, as claimed in 1, characterized by the cylindrical container of vertical axis is made of a transparent plastic material such as polycarbonate.

7. ACCELERATED AGING MINI CHAMBER FOR GLOBAL SEED VIGOR TEST, as claimed in 1, characterized by the cylindrical container of vertical axis is made of a transparent plastic material such as polypropylene.
